(19) United States
(12) Patent Application Publication
(10) Pub. No.: US 2026/0145326 A1
(43) Pub. Date: May 28, 2026

(54) HUMANOID ROBOT CONTROL METHOD, ROBOT, AND COMPUTER-READABLE STORAGE MEDIUM

(71) Applicant: UBTECH ROBOTICS CORP LTD, Shenzhen (CN)

(72) Inventors: ZHIHAO ZHANG, Shenzhen (CN); Ligang Ge, Shenzhen (CN); Weniong Qin, Shenzhen (CN)

(21) Appl. No.: 19/078,321

(22) Filed: Mar. 13, 2025

(30) Foreign Application Priority Data
Nov. 22, 2024 (CN) 202411688658.6

(51) Int. Cl. B25J 9/16

(52) U.S. Cl. CPC B25J 9/1664

(57) ABSTRACT

A humanoid robot control method, a robot, and a computer-readable storage medium are provided. The method includes: obtaining, in response to a humanoid robot updating a whole-body state, a target position of an operating object in whole-body space reachability information of the humanoid robot; determining a target motion mode based on the target position and subspace reachability information of each movable part; and controlling, according to the target motion mode, target movable part(s) among the movable parts to perform a target operation on the operating object. By making efficient decisions regarding the motion modes of the humanoid robot, the ability of the humanoid robot to flexibly switch the motion modes in a factory environment is improved, thereby enhancing the control accuracy of humanoid robots.

### CROSS REFERENCE TO RELATED APPLICATIONS

The present disclosure claims priority to Chinese Patent Application No. 202411688658.6, filed Nov. 22, 2024, which is hereby incorporated by reference herein as if set forth in its entirety.

### TECHNICAL FIELD

The present disclosure relates to robot technology, and particularly to a humanoid robot control method, a robot, and a computer-readable storage medium.

### BACKGROUND

With the development of robotics technology, various types of robots have gradually emerged. In order to adapt to various scenarios, humanoid robots are provided for related operations. Since the application scenarios of humanoid robots are usually more complex, how to improve the control accuracy of the type of robots has become an urgent problem.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a humanoid robot control method according to an embodiment of the present disclosure.

FIG. 2 is a flow chart of a humanoid robot control method according to another embodiment of the present disclosure.

FIG. 3 is a flow chart of a humanoid robot control method according to still another embodiment of the present disclosure.

FIG. 4 is a flow chart of a humanoid robot control method according to the other embodiment of the present disclosure.

FIG. 5 is a schematic diagram of the structure of a control apparatus of a humanoid robot according to an embodiment of the present disclosure.

### DETAILED DESCRIPTION

The technical solutions in the embodiments of the present disclosure will be clearly and completely described below in conjunction with the drawings in the embodiments of the present disclosure. Apparently, the following embodiments are only part of the embodiments of the present disclosure, not all of the embodiments of the present disclosure.

The components of the embodiments of the present disclosure that are described and illustrated in the drawings herein may generally be arranged and designed in a variety of different configurations. Therefore, the following detailed description of the embodiments of the present disclosure provided in the drawings is not intended to limit the scope of the present disclosure, but merely represent the selected embodiments of the present disclosure. Based on the embodiments of the present disclosure, all other embodiments obtained by those of ordinary skill in the art without creative work fall within the protection scope of the present disclosure.

In the following, the terms “including”, “having” and their cognates that can be used in the embodiments of the present disclosure are only intended to indicate specific features, numbers, steps, operations, elements, components or their combinations, and should not be understood as for excluding the existence of one or more other features, numbers, steps, operations, elements, components or their combinations, or the possibility of increasing one or more features, numbers, steps, operations, elements, components or their combinations.

In addition, the terms “first”, “second”, “third”, and the like in the descriptions are only used for distinguishing, and cannot be understood as indicating or implying relative importance.

Unless otherwise defined, all terms (including technical terms and scientific terms) used herein have the same meaning as those generally understood by ordinary technicians in the field to which the embodiments of the present disclosure belong. The terms (e.g., those defined in generally used dictionaries) should be interpreted as having the same meaning as the contextual meaning in the relevant technical field and will not be interpreted as having an idealized meaning or an overly formal meaning unless clearly defined in the embodiments of the present disclosure.

### Embodiment 1

In this embodiment, a control method for a humanoid robot is provided, which can improve the control accuracy of the humanoid robot, thereby improving the control effect of the humanoid robot.

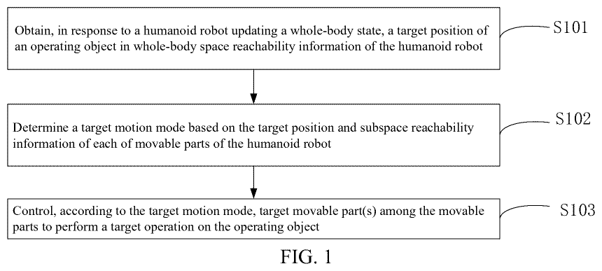

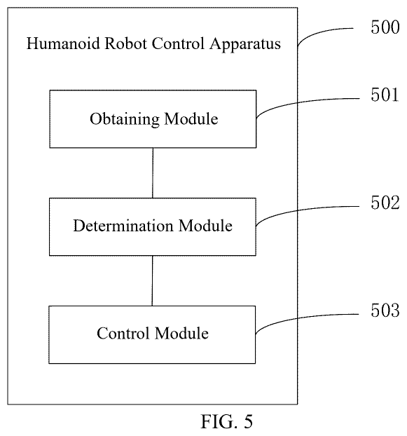

FIG. 1 is a flow chart of a humanoid robot control method according to an embodiment of the present disclosure. In this embodiment, the humanoid robot control method includes steps S101-S103, which is applied to (a processor of) a humanoid robot. The humanoid robot includes a plurality of movable parts, for example, a single leg part, a bipedal part, a waist part, and a single arm part, bi-arm parts, and a head part. The humanoid robot may perform various operations in industrial scenarios such as vehicle appearance inspection, part sorting, and heavy object handling. In other embodiments, the method may be implemented through a control apparatus for the humanoid robot as shown in FIG. 5. As shown in FIG. 1, in this embodiment, the humanoid robot control method may include the following steps.
S101: obtaining, in response to the humanoid robot updating a whole-body state, a target position of an operating object in whole-body space reachability information of the humanoid robot.

In this embodiment, it may divide motion spaces of the humanoid robot according to the movable parts of the humanoid robot, and set the corresponding basic operation mode for each motion space or each movable part. The humanoid robot may receive operation instructions input by the user to determine an operation object according to the operation instructions. The operation object may be various to-be-operated components, to-be-detected vehicles, or the like. The humanoid robot updates the whole-body state periodically (e.g., at each control cycle), determines the whole-body space reachability information, and determines the target position of the operating object in the whole-body space reachability information. In which, the whole-body state may include the angles of all joints of the humanoid robot in a control cycle. The whole-body space reachability information may include a set of three-dimensional (3D) motion spaces that all the joints of the humanoid robot can move within. Each element in the set of three-dimensional motion spaces represent a three-dimensional motion range in which each movable part can move. After discretizing the configuration space (i.e., the ranges of the motion angle of all the joints of the robot), a set of all the motion spaces is obtained through forward kinematics. The biped motion space corresponds to forward movement, lateral movement, and in-situ rotation, which includes x-axis, y-axis, and a rotation angle about the y-axis. The waist motion space is caused by the movement of two legs, which includes the x-axis, the y-axis, z-axis, a rotation angle about the x-axis, a rotation angle about the y-axis, and a rotation angle about the z-axis. The bi-arm motion space refers to the motion space of the end of two arms, which is generated by the joint movement of the arms, and also includes the x-axis, the y-axis, the z-axis, the rotation angle about the x-axis, the rotation angle about the y-axis, and the rotation angle about the z-axis. The subspace reachability information is the three-dimensional motion space that can be reached by each movable part.

In this embodiment, the humanoid robot may include a modal selector, which traverses in each control cycle. After the humanoid robot updates the whole-body state, the modal selector obtains the target position of the operating object in the whole-body space reachability information of the humanoid robot
S102: determining a target motion mode based on the target position and subspace reachability information of each of the movable parts

In this embodiment, the modal selector may judge whether the target position has an intersection area with each subspace reachability information. Based on the judgment result of whether there is the intersection area, a target motion mode may be determined from a plurality of basic operation modes, thereby improving the control accuracy of the humanoid robot.

In this embodiment, the target motion mode may be one of a plurality of basic operation modes each corresponding to one of the movable parts. For example, there may be a biped motion mode corresponding to the biped part, a waist motion mode corresponding to the waist part, a bi-arm motion mode corresponds to the bi-arm part, and a head motion mode corresponding to the head part.

In one embodiment, the method may further include:
configuring a basic operation mode corresponding to each of the movable parts of the humanoid robot, where the basic operation mode includes at least one of a biped motion mode, a waist motion mode, a bi-arm motion mode, a left arm motion mode, a right arm motion mode, and head motion mode.

For example, for the humanoid robot, a variety of basic operation modes M may be defined, namely biped motion mode M1, waist motion mode M2, bi-arm motion mode M3, and head motion mode M4. In this embodiment, the humanoid robot includes the modal selector, which may be used to switch among the modes. In this way, a corresponding basic operation mode may be defined for each movable part so as to facilitate the subsequent precise control of each movable part according to needs.

In this embodiment, the whole-body space reachability information may include a whole-body reachability map, and the subspace reachability information may include reachability submaps. For example, it may determine the target position G of the operating object in the whole-body reachability map R of the humanoid robot, where the whole-body reachability map R is a discrete three-dimensional sequence that represents the points where the humanoid robot can reach in the space under the body coordinate system of the humanoid robot. A reachability submap Ri may be created based on each movable part of the robot, where i is a positive integer larger than or equal to 1. For example, accessible submap Ri may include biped motion space map R1, waist motion space map R2, bi-arm motion space map R3, left arm motion space map R4, right arm motion space map R5, and head motion space map R6. In which, the head motion space map R6 may be obtained by superimposing the movable space of the head part with the field-of-view of a camera at the head part. It should be noted that the field-of-view of the camera has a quadrangular shape.

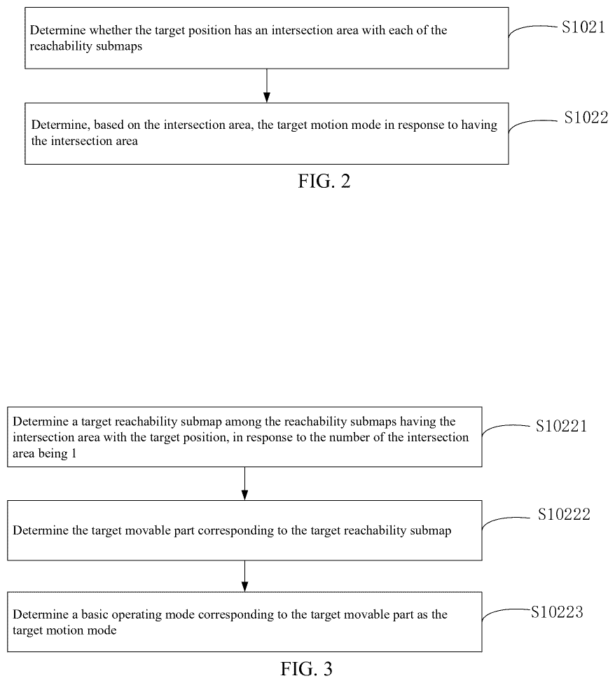

FIG. 2 is a flow chart of a humanoid robot control method according to another embodiment of the present disclosure. As shown in FIG. 2, step S102 may include:
S1021: determining whether the target position has an intersection area with each of the reachability submaps.
S1022: determining, based on the intersection area, the target motion mode in response to having the intersection area.

It should be added that if the target position does not have an intersection area with any of the reachability submaps, it should be determined that the humanoid robot is completely unreachable to the operation object, and it is necessary to control the humanoid robot to move to the operation object and re-enter the step S101.

For example, if the operating object is in the target position G of the whole-body accessibility diagram R of the humanoid robot, and the reachability submap Ri includes: biped motion space map R1, waist motion space map R2, bi-arm motion space map R3, left arm motion space map R4, right arm motion space map R5, and head motion space map R6, it will determine the result of

$${⋃}_{i = 1}^{6} G ⋂ Ri .$$

The results of G∩Ri in this category is as below: G∩R1=Ø represents the humanoid robot cannot reach the operation object on both legs, G∩R2=Ø represents the waist cannot reach the operation object, G∩R3=Ø represents the bi-arm cannot reach the operation object, G∩R4=Ø represents the left arm cannot reach the operation object, G∩R5=Ø represents the right arm cannot reach the operation object, and G∩R6=Ø represents the operation object is lost in the field-of-view of the robot. Each reachable situation is as follows: G∩R1≠Ø represents the humanoid robot can reach the operating object by moving both legs, G∩R2≠Ø represents the humanoid robot can reach the operating object by moving its waist, G∩R3≠Ø represents the humanoid robot can reach the operating object by moving bi-arm, G∩R4≠Ø represents the humanoid robot can reach the operating object by moving the left arm, G∩R5≠Ø represents the humanoid robot can reach the operating object by moving the right arm, and G∩R6≠Ø represents the operation object is in the field-of-view of the robot. It should be noted that if there are a plurality of intersection areas, it means that the humanoid robot can reach the operating object by moving a plurality of movable parts. For example, G∩R1≠Ø and G∩R2≠Ø represent the robot can reach the operating object by either moving both legs or moving the waist.

FIG. 3 is a flow chart of a humanoid robot control method according to still another embodiment of the present disclosure. As shown in FIG. 3, step S1022 may include:
S10221: determining a target reachability submap among the reachability submaps having the intersection area with the target position, in response to the number of the intersection area being 1;
S10222: determining the target movable part corresponding to the target reachability submap; and
S10223: determining a basic operation mode corresponding to the target movable part as the target motion mode.

For example, if G∩R1≠Ø, G∩R2=Ø, G∩R3=Ø, G∩R4=Ø, G∩R5=Ø, and G∩R6=Ø, then biped motion space map R1 is the target reachability submap, the target movable part is the bipedal part, and biped motion mode M1 is the target movable mode.

In this way, the target motion mode can be quickly determined, thereby improving and the control accuracy of the movable parts.

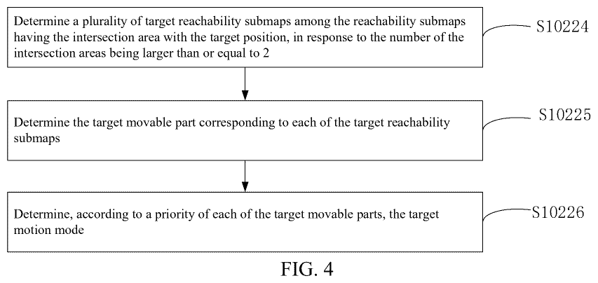

FIG. 4 is a flow chart of a humanoid robot control method according to the other embodiment of the present disclosure. As shown in FIG. 4, step S1022 may include:
S10224: determining a plurality of target reachability submaps among the reachability submaps having the intersection area with the target position, in response to the number of the intersection areas being larger than or equal to 2;
S10225: determining the target movable part corresponding to each of the target reachability submaps; and
S10226: determining, according to a priority of each of the target movable parts, the target motion mode.

In this embodiment, the priority of each of the target movable parts may be determined according to the degree of influence of the movable part on the stability of the humanoid robot. For example, biped part has the highest priority, the waist has the lower priority, and biped part has the lowest priority. In addition, if G∩R1≠Ø, G∩R2≠Ø, G∩R3=Ø, G∩R4=Ø, G∩R5=Ø, and G∩R6=Ø, biped motion space map R1 and waist motion space map R2 are both the target reachability submaps. The target movable parts are the biped part and the waist part. Biped motion mode M1 and waist motion mode M2 are candidate motion modes. If the biped part has the highest priority, biped motion mode M1 is determined as the target motion model. In this way, while ensuring the stability of the humanoid robot, the target motion mode is quickly determined, thereby improving the control accuracy of the movable part.

In some embodiments, the movable parts may include a head part of the humanoid robot, and the subspace reachability information includes head motion space information. The method may further include:
obtaining a shortest distance between a center of a field-of-view of a camera of the head part and the operating object, in response to the target position not having an intersection area with the head motion space information; and
aligning, according to the shortest distance, the center of the field-of-view of the camera with the operation object.

In this embodiment, a corresponding motion may be performed based on the result of the calculated intersection of the target position G and each reachability submap Ri. Specifically, the calculated intersections of the target position G and the reachability submaps R1, R2, R3, R4, R5 and R6 may be put into the stack one by one, and then pop them out one by one. If the pop result is 0, then do the next pop until the bottom of the stack. According to the pop result, it determines to use the corresponding motion mode M. As an example, if G∩R1≠Ø, the humanoid robot directly enters biped motion mode M1. As another example, if G∩R1=Ø and G∩R2≠Ø, the humanoid robot enters waist motion mode M2. If

$${⋃}_{i = 1}^{5} G ⋂ Ri$$

is empty, it means that the robot is completely unreachable to the target position G, and if G∩R6=Ø, it calculates the shortest distance between the center of field-of-view of the camera of the head part from the target position G, and then control the center of field-of-view of the head part to align to the target position G through an interpolation algorithm. In which, the interpolation algorithm may be a polynomial interpolation algorithm.

In some embodiments, the head motion space information may be obtained by:
determining an accessible space of the head part;
determining the field-of-view of the camera; and
obtaining the head motion space information by superimposing the accessible space and the field-of-view.

In this embodiment, the head motion space information may include a head motion space map, which may be obtained by superimposing the accessible space map of the head part with the field-of-view of the camera so as to ensure that the accessible space of the head part is consistent with the actual situation.
S103: controlling, according to the target motion mode, target movable part(s) among the movable parts to perform a target operation on the operating object.

In this embodiment, it fully utilizes the advantages of the humanoid robot by providing a general and flexible control method for humanoid robots to realize autonomous switching of the whole-body motions of the robots. The target operation may be a series of operations that can control the humanoid robot to perform various operations in industrial scenarios like vehicle appearance inspection, part sorting, and heavy object handling.

In this embodiment, the humanoid robot control method is provided to obtain, in response to the humanoid robot updating a whole-body state, a target position of an operating object in whole-body space reachability information of the humanoid robot; determine a target motion mode based on the target position and subspace reachability information of each movable part; and control, according to the target motion mode, target movable part(s) among the movable parts to perform a target operation on the operating object. By making efficient decisions regarding the motion modes of the humanoid robot, the ability of the humanoid robot to flexibly switch the motion modes in a factory environment is improved, thereby enhancing the control accuracy of humanoid robots.

### Embodiment 2

In addition, in this embodiment, a humanoid robot control apparatus is provided.

FIG. 5 is a schematic diagram of the structure of a control apparatus 500 for a humanoid robot according to an embodiment of the present disclosure. In this embodiment, the humanoid robot like the above-mentioned robot includes a plurality of movable parts, and the control apparatus 500 may be a controller of the robot such as the above-mentioned modal selector.

As shown in FIG. 5, the control apparatus 500 for the humanoid robot may include:
an obtaining module 501 configured to obtain, in response to the humanoid robot updating a whole-body state, a target position of an operating object in whole-body space reachability information of the humanoid robot;
a determination module 502 configured to determine a target motion mode based on the target position and subspace reachability information of each of the movable parts, where the target motion mode is one of a plurality of basic operation modes each corresponding to one of the movable parts; and
a control module 503 configured to control, according to the target motion mode, movable part(s) among the movable parts to perform a target operation on the operating object.

In one embodiment, the whole-body space reachability information may include a whole-body reachability map, and the subspace reachability information may include reachability submaps. The determination module 502 may be further configured to:
determine whether the target position has an intersection area with each of the reachability submaps;
determine, based on the intersection area, the target motion mode in response to having the intersection area.

In one embodiment, the determination module 502 may be further configured to:
determine a target reachability submap among the reachability submaps having the intersection area with the target position, in response to the number of the intersection area being 1;
determine the target movable part corresponding to the target reachability submap; and
determine a basic operation mode corresponding to the target movable part as the target motion mode.

In one embodiment, the determination module 502 may be further configured to:
determine a plurality of target reachability submaps among the reachability submaps having the intersection area with the target position, in response to the number of the intersection areas being larger than or equal to 2;
determine the target movable part corresponding to each of the target reachability submaps; and
determine, according to a priority of each of the target movable parts, the target motion mode.

In one embodiment, the movable parts may include a head part of the humanoid robot, and the subspace reachability information may include head motion space information. The control apparatus 500 of the humanoid robot may further include a first processing module configured to: obtain a shortest distance between a center of a field-of-view of a camera of the head part and the operating object, in response to the target position not having an intersection area with the head motion space information; and align, according to the shortest distance, the center of the field-of-view of the camera with the operation object.

In one embodiment, the control apparatus 500 of the humanoid robot may further include a second processing module configured to:
determine an accessible space of the head part, and determine the field-of-view of the camera; and
obtain the head motion space information by superimposing the accessible space and the field-of-view.

In one embodiment, the control apparatus 500 of the humanoid robot may further include a configuration module configured to:
configure a basic operation mode corresponding to each of the movable parts of the humanoid robot, where the basic operation mode includes at least one of a biped motion mode, a waist motion mode, a bi-arm motion mode, a left arm motion mode, a right arm motion mode, and head motion mode.

In this embodiment, the provided control apparatus 500 of the humanoid robot can implement the control method for the humanoid robot provided by Embodiment 1.

In this embodiment, the control apparatus for the humanoid robot is provided to obtain, in response to the humanoid robot updating a whole-body state, a target position of an operating object in whole-body space reachability information of the humanoid robot; determine a target motion mode based on the target position and subspace reachability information of each movable part; and control, according to the target motion mode, target movable part(s) among the movable parts to perform a target operation on the operating object. By making efficient decisions regarding the motion modes of the humanoid robot, the ability of the humanoid robot to flexibly switch the motion modes in a factory environment is improved, thereby enhancing the control accuracy of humanoid robots.

### Embodiment 3

Furthermore, in this embodiment, a humanoid robot is provided. The humanoid robot may include a storage and a processor, where the storage stores a computer program. The control method for the humanoid robot that is provided in Embodiment 1 is performed when the computer program is executed on the processor.

In this embodiment, the provided humanoid robot can realize the control method for the humanoid robot that is provided by Embodiment 1.

### Embodiment 4

Still furthermore, in this embodiment, a computer-readable storage medium is provided, where the storage medium stores a computer program. The control method for the humanoid robot that is provided in Embodiment 1 is realized when the computer program is executed on a processor of, for example, the above-mentioned humanoid robot.

In this embodiment, the computer-readable storage medium may be read-only memory (ROM), Random Access Memory (RAM), magnetic disk, optical disk, or the like.

In this embodiment, the provided computer-readable storage medium can realize the control method for the humanoid robot that is provided by Embodiment 1.

It should be noted that, in the present disclosure, the terms “comprising”, “including”, or any other variations thereof are intended to cover non-exclusive inclusions such that a process, method, object or terminal including a series of elements includes not only those elements but also other elements that are not explicitly listed, or also includes elements inherent in such process, method, object or terminal. In the case of no further limitations, the element defined by the statement “including a . . . ” does not exclude the existence of additional identical elements in the process, method, object or terminal including the element.

Through the forgoing description of the embodiments, those skilled in the art could clearly understand that the above-mentioned embodiments can be implemented through software and a necessary general hardware platform, or alternatively through hardware while in many cases the former is better choice. Based on this understanding, the technical solution of the present disclosure, either essentially or in part, contributes to the prior art, or a part of the technical solution can be embodied in the form of a software product which is stored in a storage medium (e.g., ROM/RAM, disk, and optical disc) including a plurality of instructions for causing a terminal (which may be a mobile phone, computer, server, air conditioner, network device, or the like) to perform the method described in various embodiments of the present disclosure.

Although the embodiments of the present disclosure have been described above in conjunction with the drawings, the present disclosure is not limited to the above-mentioned specific embodiments because those embodiments are only schematic and not restrictive. Hence, there are still many other variations can be made by those skilled in the art without departing from the purpose of the present disclosure and the scope of the claims, and all of those variations will fall within the scope of the present disclosure.

What is claimed is:

1. A method for controlling a humanoid robot having a plurality of movable parts, comprising:
obtaining, in response to the humanoid robot updating a whole-body state, a target position of an operating object in whole-body space reachability information of the humanoid robot;
determining a target motion mode based on the target position and subspace reachability information of each of the movable parts, wherein the target motion mode is one of a plurality of basic operation modes each corresponding to one of the movable parts; and
controlling, according to the target motion mode, one or more target movable parts among the movable parts to perform a target operation on the operating object.

2. The method of claim 1, wherein the whole-body space reachability information includes a whole-body reachability map, and the subspace reachability information includes reachability submaps; wherein determining a target motion mode based on the target position and subspace reachability information of each of the movable parts comprises:
determining whether the target position has an intersection area with each of the reachability submaps;
determining, based on the intersection area, the target motion mode in response to having the intersection area.

3. The method of claim 2, wherein determining, based on the intersection area, the target motion mode comprises:
determining a target reachability submap among the reachability submaps having the intersection area with the target position, in response to the number of the intersection area being 1;
determining the target movable part corresponding to the target reachability submap; and
determining a basic operation mode corresponding to the target movable part as the target motion mode.

4. The method of claim 2, wherein determining, based on the intersection area, the target motion mode comprises:
determining a plurality of target reachability submaps among the reachability submaps having the intersection area with the target position, in response to the number of the intersection areas being larger than or equal to 2;
determining the target movable part corresponding to each of the target reachability submaps; and
determining, according to a priority of each of the target movable parts, the target motion mode.

5. The method of claim 1, wherein the movable parts include a head part of the humanoid robot, and the subspace reachability information includes head motion space information; wherein the method further comprises:
obtaining a shortest distance between a center of a field-of-view of a camera of the head part and the operating object, in response to the target position not having an intersection area with the head motion space information; and
aligning, according to the shortest distance, the center of the field-of-view of the camera with the operation object.

6. The method of claim 5, the head motion space information is obtained by:
determining an accessible space of the head part;
determining the field-of-view of the camera; and
obtaining the head motion space information by superimposing the accessible space and the field-of-view.

7. The method of claim 1, further comprising:
configuring a basic operation mode corresponding to each of the movable parts of the humanoid robot, wherein the basic operation mode includes at least one of a biped motion mode, a waist motion mode, a bi-arm motion mode, a left arm motion mode, a right arm motion mode, and head motion mode.

8. An apparatus for controlling a humanoid robot having a plurality of movable parts, comprising:
an obtaining module configured to obtain, in response to the humanoid robot updating a whole-body state, a target position of an operating object in whole-body space reachability information of the humanoid robot;
a determination module configured to determine a target motion mode based on the target position and subspace reachability information of each of the movable parts, wherein the target motion mode is one of a plurality of basic operation modes each corresponding to one of the movable parts; and
a control module configured to control, according to the target motion mode, one or more target movable parts among the movable parts to perform a target operation on the operating object.

8. A robot, comprising:
a plurality of movable parts;
a processor;
a memory coupled to the processor; and
one or more computer programs stored in the memory and executable on the processor;
wherein, the one or more computer programs comprise:
instructions for obtaining, in response to the humanoid robot updating a whole-body state, a target position of an operating object in whole-body space reachability information of the humanoid robot;
instructions for determining a target motion mode based on the target position and subspace reachability information of each of the movable parts, wherein the target motion mode is one of a plurality of basic operation modes each corresponding to one of the movable parts; and
instructions for controlling, according to the target motion mode, one or more target movable parts among the movable parts to perform a target operation on the operating object.

9. The robot of claim 8, wherein the whole-body space reachability information includes a whole-body reachability map, and the subspace reachability information includes reachability submaps; wherein the instructions for determining a target motion mode based on the target position and subspace reachability information of each of the movable parts comprise:
instructions for determining whether the target position has an intersection area with each of the reachability submaps;
instructions for determining, based on the intersection area, the target motion mode in response to having the intersection area.

10. The robot of claim 9, wherein the instructions for determining, based on the intersection area, the target motion mode comprise:
instructions for determining a target reachability submap among the reachability submaps having the intersection area with the target position, in response to the number of the intersection area being 1;
instructions for determining the target movable part corresponding to the target reachability submap; and
instructions for determining a basic operation mode corresponding to the target movable part as the target motion mode.

11. The robot of claim 9, wherein the instructions for determining, based on the intersection area, the target motion mode comprise:
instructions for determining a plurality of target reachability submaps among the reachability submaps having the intersection area with the target position, in response to the number of the intersection areas being larger than or equal to 2;
instructions for determining the target movable part corresponding to each of the target reachability submaps; and
instructions for determining, according to a priority of each of the target movable parts, the target motion mode.

12. The robot of claim 8, wherein the movable parts include a head part of the humanoid robot, and the subspace reachability information includes head motion space information; wherein the one or more computer program further comprise:
instructions for obtaining a shortest distance between a center of a field-of-view of a camera of the head part and the operating object, in response to the target position not having an intersection area with the head motion space information; and
instructions for aligning, according to the shortest distance, the center of the field-of-view of the camera with the operation object.

13. The robot of claim 12, the head motion space information is obtained by:
determining an accessible space of the head part;
determining the field-of-view of the camera; and
obtaining the head motion space information by superimposing the accessible space and the field-of-view.

14. The robot of claim 8, wherein the one or more computer program further comprise:
instructions for configuring a basic operation mode corresponding to each of the movable parts of the humanoid robot, wherein the basic operation mode includes at least one of a biped motion mode, a waist motion mode, a bi-arm motion mode, a left arm motion mode, a right arm motion mode, and head motion mode.

15. A non-transitory computer-readable storage medium for storing one or more computer programs, wherein the one or more computer programs comprise:
instructions for obtaining, in response to a humanoid robot updating a whole-body state, a target position of an operating object in whole-body space reachability information of the humanoid robot;
instructions for determining a target motion mode based on the target position and subspace reachability information of each of movable parts of the humanoid robot, wherein the target motion mode is one of a plurality of basic operation modes each corresponding to one of the movable parts; and
instructions for controlling, according to the target motion mode, one or more target movable parts among the movable parts to perform a target operation on the operating object.

16. The storage medium of claim 15, wherein the whole-body space reachability information includes a whole-body reachability map, and the subspace reachability information includes reachability submaps; wherein the instructions for determining a target motion mode based on the target position and subspace reachability information of each of the movable parts comprise:
instructions for determining whether the target position has an intersection area with each of the reachability submaps;
instructions for determining, based on the intersection area, the target motion mode in response to having the intersection area.

17. The storage medium of claim 16, wherein the instructions for determining, based on the intersection area, the target motion mode comprise:
instructions for determining a target reachability submap among the reachability submaps having the intersection area with the target position, in response to the number of the intersection area being 1;
instructions for determining the target movable part corresponding to the target reachability submap; and
instructions for determining a basic operation mode corresponding to the target movable part as the target motion mode.

18. The storage medium of claim 16, wherein the instructions for determining, based on the intersection area, the target motion mode comprise:
instructions for determining a plurality of target reachability submaps among the reachability submaps having the intersection area with the target position, in response to the number of the intersection areas being larger than or equal to 2;
instructions for determining the target movable part corresponding to each of the target reachability submaps; and
instructions for determining, according to a priority of each of the target movable parts, the target motion mode.

19. The storage medium of claim 15, wherein the movable parts include a head part of the humanoid robot, and the subspace reachability information includes head motion space information; wherein the one or more computer program further comprise:
instructions for obtaining a shortest distance between a center of a field-of-view of a camera of the head part and the operating object, in response to the target position not having an intersection area with the head motion space information; and
instructions for aligning, according to the shortest distance, the center of the field-of-view of the camera with the operation object.

20. The storage medium of claim 19, the head motion space information is obtained by:
determining an accessible space of the head part;
determining the field-of-view of the camera; and
obtaining the head motion space information by superimposing the accessible space and the field-of-view.
